(19) United States
(12) Patent Application Publication
(10) Pub. No.: US 2010/0006781 A1
(43) Pub. Date: Jan. 14, 2010

(54) HOLLOW GRID AND MANUFACTURING METHOD THEREOF

(75) Inventor: Hiromichi Tonami, Kyoto (JP)

Correspondence Address: J C PATENTS, 4 VENTURE, SUITE 250, IRVINE, CA, 92618, US

(73) Assignee: SHIMADZU CORPORATION, Kyoto (JP)

(21) Appl. No.: 12/374,972

(22) PCT Filed: Aug. 25, 2006
(86) PCT No.: PCT/JP2006/316695

§ 371 Date: Jan. 23, 2009

(30) Foreign Application Priority Data
Aug. 25, 2006 (JP) PCT/JP2006/316695

(51) Int. Cl. G21F 3/00; B23P 11/00

(52) U.S. Cl. 250/515.1; 29/428

(57) ABSTRACT

A hollow grid that can be manufactured easily, capable of inhibiting the generation of moire fringes, and absorbing less transmitted X-rays is provided. The hollow grid uses no intermediate material that is capable of transmitting the X-rays. X-ray shielding members are located at intervals of an integral multiple of a pixel pitch of a two-dimensional radiation detector. The X-ray shielding members are held by adhering to the upper and lower wrapping members. Therefore, through a sensitivity correction, the structure, in which the generation of moire fringe is difficult, is provided. Since the hollow grid is assembled by means of an assembling jig, the intervals of the X-ray shielding members can be formed easily with high precision. The quality variation of the completed hollow grids is small, and the product precision is high.

### BACKGROUND OF THE INVENTION

1. Field of the Invention

The present invention relates to an anti-scattered hollow grid disposed on a front surface of a two-dimensional radiation detector for performing radiation photography and a manufacturing method thereof.

2. Description of Related Art

Recently, attention has been directed to a two-dimensional radiation detector called flat panel detector (FPD). It is well-known that the FPDs are categorized into direct conversion FPDs and indirect conversion FPDs. In a direct conversion FPD, after X-ray energy is directly converted into charges, a thin-film transistor (TFT) or other reading element reads the charges as an electric signal. In an indirect conversion FPD, after the X-ray energy is converted to light by a scintillator, a photoelectric converting element converts the converted light into charges, and then the TFT or other reading element reads the charges as an electric signal. In both types, the information about a shot body, in which light is converged on a surface of the detector, is read as the information sampled in space according to a reading element pitch (hereinafter referred to as a detector pitch).

As shown in FIG. 9, when an X-ray 111 is shot on a shot body 110, a part of the X-ray is absorbed by the shot body 110, and the remaining X-ray, that is, the transmitted X-ray 112, is not absorbed by the shot body 110, and reaches a detector 102. In another aspect, in addition to the transmitted X-ray 112 penetrating the shot body 110, a noise component, that is, a scattered ray 113 is released from the shot body 11. The scattered ray 113 reduces a signal to noise ratio (SNR) or a contrast of the picture information of the shot body 110 that should be formed by the transmitted X-ray 112. Therefore, a grid 101 is normally used to remove the scattered component as much as possible.

The grid 101 includes X-ray shielding members 103 arranged in strips at fixed intervals with an intermediate material 104 sandwiched there-between. The scattered ray 113 may be absorbed by the X-ray shielding members 103 and will not reach the detector 102. Thus, the SNR and the contrast of the picture information can be increased. However, when a secondary scattered ray 116 is generated in the intermediate material, the scattered ray 116 may not be entirely removed.

Generally, a grid ratio or a grid density is used as a value representing the anti-scattered capability of the grids, and the value is determined by a thickness C and a height A of the X-ray shielding member, and a thickness B of the intermediate material, as shown in FIG. 10. The grid ratio is specified as r=A/B, and the grid density is determined as N=1/(B+C) [line/cm]. The grid ratio or grid density is selected according to the type and purpose of the detector. The grids are categorized into moving grids and fixed grids. For a moving grid, the grid and the X-ray shot synchronously move towards a direction vertical to a grid fringe direction, such that a fixed pattern of the grid is not imaged in the picture. For a fixed grid, the detector is shot when the grid is fixed. In a photographing method using the grid, under the situation that the fixed grid is used, the shot body information reaching the detector includes a fixed pattern of the grid fringe.

The moving grid has the following problems: although the fixed pattern of the grid fringe does not exist, the X-ray shielding members may cut off the X-ray when moving, such that the amount of X-ray is insufficient, which may lower the picture quality. In addition, a mechanism enabling the grid to move mechanically is required. Hence, the device has a large size and the cost is high. Further, vibration generated during moving or electrical noise of a motor required during moving seriously affects the pictures.

In another aspect, when the fixed grid is used and when the picture including the fixed pattern of the grid fringe is digitized, sometimes a fringe pattern called the moire fringe, which does not exist originally, may occur according to a relationship between a sampling frequency and a grid frequency determined by the pixel pitch of the two-dimensional radiation detector. The moire fringe becomes the noise information relative to the picture information of the shot body, and seriously influences the diagnosis of doctors. In order to prevent the moire fringe, a grid having a frequency of an integral multiple of the sampling frequency is used (for example, refer to Patent Document 1).

However, under the existing technical conditions, manufacturing error definitely occurs, resulting in the moire fringe.

Patent Document 1: Japanese Patent Publication Number 2002-257939

### SUMMARY OF THE INVENTION

However, from the manufacture perspective, it is difficult to manufacture such a grid, in which X-ray shielding members 1 are precisely arranged at an interval of an integral multiple of a sampling frequency (a pixel pitch of the two-dimensional radiation detector), and each X-ray shielding member 1 is disposed precisely oblique towards a X-ray source direction. Accordingly, the present invention is directed to a method for easily manufacturing a grid with high precision.

In claim 1, a hollow grid includes a plurality of radiation shielding members, which are obliquely disposed and have extending surfaces converged toward a straight line; a plurality of wrapping members, adhered to and fixed on radiation incident sides of the plurality of radiation shielding members; and a plurality of wrapping members, adhered to and fixed on sides opposite to the radiation incident sides of the plurality of radiation shielding members.

Further, in claim 2, a method for manufacturing a hollow grid includes: Step (A) of respectively inserting a plurality of radiation shielding members in an assembling jig composed by a slot board with a plurality of formed specified slots, such that the plurality of radiation shielding members are obliquely disposed and have extending surfaces converged on a straight line; Step (B) of adhering wrapping members to radiation incident sides or sides opposite to the radiation incident sides of the X-ray shielding members for curing Step (C) of making the assembling jig slide, and adhering wrapping members to the other sides of the X-ray shielding members for curing; Step (D) of repeating Steps (B) and (C) until the plurality of wrapping members is adhered to the radiation incident sides and the opposite sides of all the X-ray shielding members.

### EFFECT OF INVENTION

The hollow grid of the present invention does not include an intermediate material for transmitting the X-ray. The X-ray shielding members are located at intervals of an integral multiple of the pixel pitch of the two-dimensional radiation detector. Through a sensitivity correction performed on a picture signal detected by the two-dimensional radiation detector, the moire fringe may be easily removed. Further, since there is no intermediate material, a two-dimensional radiation detector with high sensitivity is formed.

As described above, since the hollow grid of the present invention is assembled with an assembling jig, the intervals of the X-ray shielding members are controlled with high precision. Thus, a detector capable of suppressing the generation of the moire fringe is provided. In addition, since an assembling jig is used for the assembling, the quality variation of the completed hollow grids is small, and the product precision is high.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an outside view of a hollow grid of a two-dimensional radiation detector according to an embodiment of the present invention.

FIG. 2 is a sectional view of the two-dimensional radiation detector according to the embodiment of the present invention.

FIG. 3 is a schematic view of an example of a manufacturing process of the hollow grid.

FIG. 4 is a front view of FIG. 3.

FIG. 5 is a schematic view of an example of the manufacturing process of the hollow grid.

FIG. 6 is a schematic view of an example of the manufacturing process of the hollow grid.

FIG. 7 is a schematic view of an example of the manufacturing process of the hollow grid.

FIG. 8 is a schematic view of an example of the manufacturing process of the hollow grid.

FIG. 9 is an outside view of a hollow grid of a two-dimensional radiation detector in a prior art.

FIG. 10 is a schematic view of a principle of the hollow grid.

### DESCRIPTION OF REFERENCE SYMBOLS

1 hollow grid
2 two-dimensional radiation detector
3 X-ray shielding members
6, 7 spacers
8 lateral side supporting members
10 shot body
11 Incident X-ray
12 transmitted X-ray
14 upper wrapping members
15 lower wrapping members
21 slot board slots
23 arm portion
24, 25 bed plate
101 grid
102 detector
103 X-ray shielding members
104 intermediate material
110 shot body
111 X-ray
112 transmitted X-ray
113 scattered ray
116 secondary scattered ray

### DESCRIPTION OF EMBODIMENTS

Reference will now be made in detail to the present embodiments of the invention, examples of which are illustrated in the accompanying drawings. Wherever possible, the same reference numbers are used in the drawings and the description to refer to the same or like parts.

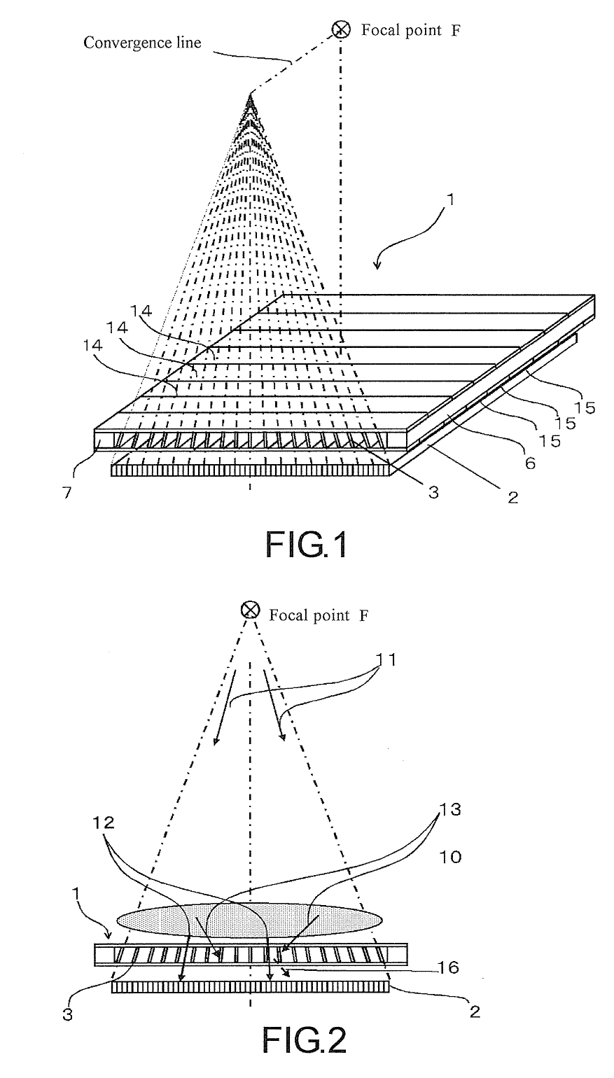

FIG. 1 is an outside view of a hollow grid 1 according to an embodiment of the present invention. X-ray shielding members 3 focus on a focal point F of an X-ray tube, and are disposed at intervals of an integral multiple of each pixel pitch on a surface of a two-dimensional radiation detector 2. In the embodiment of FIG. 1, the X-ray shielding members 3 are disposed at intervals of three times of each pixel pitch on the surface of the two-dimensional radiation detector 2. Here, a cross section of the two-dimensional radiation detector 2 is not actually divided as shown in FIG. 1, but is illustrated for better understanding as the pixel pitch depends on a pitch between the TFT elements. Radiation incident sides (hereinafter referred to as upper end surfaces) and sides opposite to the radiation incident sides (hereinafter referred to as lower end surfaces) of the X-ray shielding members 3 are supported by a plurality of upper wrapping members 14 and lower wrapping members 15. On an edge portion of the hollow grid 1, the upper wrapping members 14 and the lower wrapping members 15 are supported by spacers 6 and 7.

FIG. 2 is a sectional view of the hollow grid 1, the two-dimensional radiation detector 2, and a shot body 10. In FIG. 2, after an incident X-ray 11 emitted from the focal point F transmits through the shot body 10, the transmitted X-ray 12 passes among the X-ray shielding members 3 of the hollow grid 1 and reaches the two-dimensional radiation detector 2. In another aspect, FIG. 2 also shows a situation that a scattered ray 13 scattered in the shot body 10 is shielded by the X-ray shielding members 3. Here, an appropriate intermediate material is not present among the X-ray shielding members 3. Hence, the transmitted X-ray 12 reaches the two-dimensional radiation detector 2 without attenuation and a two-dimensional radiation detector with high sensitivity is provided. Further, no secondary scattered ray 16 is generated in the intermediate material, so good picture quality can be maintained. In addition, the X-ray shielding members 3 are disposed at the intervals of an integral multiple of each pixel pitch on the surface of the two-dimensional radiation detector. Accordingly, through sensitivity correction, the structure in which the generation of the moire fringe is obviated can be realized.

Next, the method for manufacturing the hollow grid of the present invention is described.

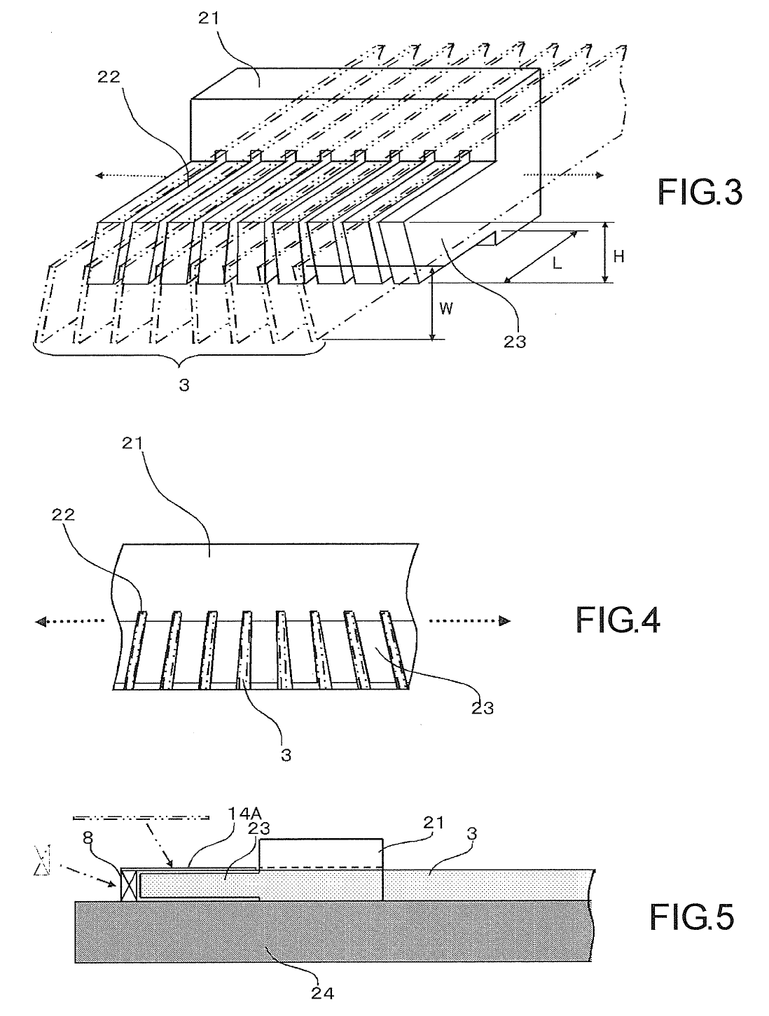

FIG. 3 shows an assembling process, and shows a position relation between a slot board 21, as an assembling jig, and the plurality of X-ray shielding members 3 (fictitious outlines). The X-ray shielding members 3 are positioned in slots 22 of the slot board 21 in an embedded state with high precision. The slots 22 focus on the focal point F (not shown) of the X-ray tube, and are formed at the intervals of an integral multiple of each pixel pitch on the surface of the two-dimensional radiation detector 2 (not shown). In FIG. 3, only 8 lines are used to show the slots 22 of the slot board 21 and the X-ray shielding members 3, but actually the number of the slots 22 and the X-ray shielding members 3 is the number required to continuously form the whole hollow grid along a direction vertical to the lateral side. A width W of the X-ray shielding members 3 is slightly shorter than a height H of an arm portion 23 of the slot board 21, and a length L of the arm portion 23 of the slot board 21 may be determined within a straightness scope in which warping is not affected. FIG. 4 is a front view of FIG. 3.

FIG. 5 is a perspective view of an assembling process of the hollow grid 1 viewed from the lateral side of FIG. 3. Here, the slot board 21 fixed on a bed plate 24 has a plurality of slots 22, and several X-ray shielding members 3 with a number required to form the final hollow grid are positioned in the slots 22 in an embedded state. In this state, the lateral sides of the X-ray shielding members 3 and lateral side supporting members 8 are adhered. Further, the upper wrapping members 14A are adhered to the X-ray shielding members 3 and the lateral side supporting members 8 for curing. In addition, the lateral side supporting members 8 wholly extend in a direction vertical to the paper surface, and have a length covering all of the plurality of the X-ray shielding members 3. During such an adhesion, the adhering member is not attached to either the arm portion 23 or the bed plate 24.

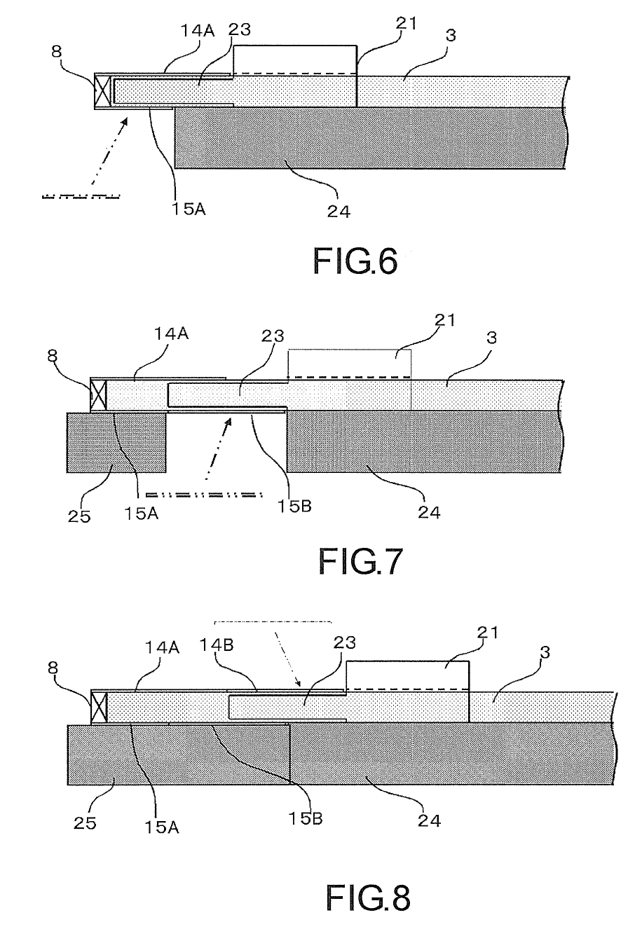

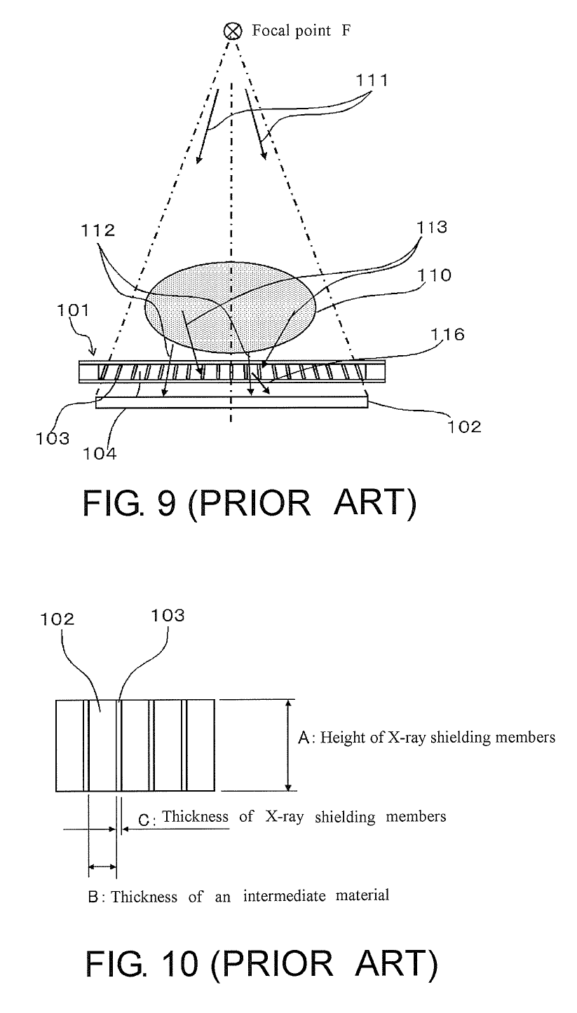

Next, the bed plate 24 as shown in FIG. 6 is made to slide relative to the slot board 21 and the X-ray shielding members 3, such that the lower wrapping members 15A are adhered to the X-ray shielding members 3 for curing. At this time, the adhering member is not attached to either the arm portion 23 or the bed plate 24.

Thereafter, the bed plate 24 and the slot board 21 as shown in FIG. 7 are made to slide relative to the X-ray shielding members 3, and further the lower part of the hollow grid is fixed by using a bed plate 25. Then, the lower wrapping members 15B are adhered to the X-ray shielding members 3 for curing. Here, the adhering member is not attached to either the arm portion 23 or the bed plate 24 and the bed plate 25.

Further, the slot board 21 as shown in FIG. 8 is made to slide relative to the X-ray shielding members 3 and the bed plate 24, and the lower part of the hollow grid is appropriately fixed by using the bed plate 25. Then, the upper wrapping members 14B are adhered to the X-ray shielding members 3 for curing. Here, the adhering member is not attached to either the arm portion 23 or the bed plate 24 and the bed plate 25. In this manner, the slot board 21, the bed plate 24 and the bed plate 25 are made to slide in sequence, and at the same time, the upper wrapping members 14 and the lower wrapping members 15 are adhered to the X-ray shielding members 3 for curing. Ultimately, the hollow grid 1 as shown in FIG. 1 is formed, and then the slot board 21 is made to slide and is removed from an end portion.

On an edge portion of the hollow grid 1, the upper wrapping members 14 and the lower wrapping members 15a sandwich and are adhered to a spacer 6 and a spacer 7, so as to improve an intensity of the hollow grid 1. In addition, in the hollow grid 1 as shown in FIG. 1, the lateral side supporting members 8 are omitted. In the method for manufacturing the hollow grid of an embodiment of the invention, the joint of the upper wrapping members 14 and the lower wrapping members 15 are configured alternately, such that the joint are not aligned along the length direction of the X-ray shielding members 3. The dispersed joint is favorable for the intensity.

In addition, a material of the X-ray shielding members 3 must be molybdenum, tungsten, lead, tantalum, a molybdenum-based alloy, a tungsten-based alloy, a lead-based alloy, or other materials with high atomic numbers and having high X-ray absorbing capability. In another aspect, a material of the upper wrapping members 14 and the lower wrapping members 15 must absorb less X-rays, be stable to temperature variation for ensuring size precision, have a small thermal expansion coefficient and have good strength. In order to satisfy these conditions, preferably, the material of the upper wrapping members 14 and the lower wrapping members 15 includes carbon fiber reinforced plastics (CFRP) and the like.

Further, in order to form the slots 22, the slot board 21 serving as the assembling jig must be processed precisely, and the method for manufacturing the slot board 21 uses a wire discharge processing machine, a dicing machine and the like.

Here, the representative dimensions of the hollow grid of the present invention are described. The pixel pitch of the two-dimensional radiation detector 2 is 0.15 mm, the thickness of the X-ray shielding members 3 is 0.03 mm, the height of the X-ray shielding members 3 is 5.7 mm, the thickness of the upper wrapping members 14 and the lower wrapping members 15 is 0.15 mm, the area size of the hollow grid 1 is 450 mm*450 mm, and the distance from the focal point F to the upper surface of the hollow grid is 1200 mm.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hollow grid, comprising:
a plurality of radiation shielding members, disposed obliquely along a row direction, wherein extending surfaces of the plurality of radiation shielding members are converged toward one straight line;
a plurality of wrapping members, arranged along a column direction, and adhered to and fixed on radiation incident sides of the plurality of radiation shielding members; and
a plurality of wrapping members, arranged along the column direction, and adhered to and fixed on sides opposite to the radiation incident sides of the plurality of radiation shielding members.

2. A method for manufacturing a hollow grid, comprising:
Step (A) of respectively inserting radiation shielding members into a plurality of slots of an assembling jig composed by a slot board with a plurality of formed specified slots, such that the radiation shielding members are obliquely disposed, and extending surfaces of the radiation shielding members are converged on one straight line;
Step (B) of adhering wrapping members to radiation incident sides or sides opposite to the radiation incident sides of the X-ray shielding members for curing;
Step (C) of making the assembling jig slide, and adhering wrapping members to the sides of the X-ray shielding members for curing;
Step (D) of repeating the Step (B) and the Step (C) until the plurality of wrapping members is adhered to the radiation incident sides and the opposite sides of all the X-ray shielding members.
